(19) United States
(12) Patent Application Publication
(10) Pub. No.: US 2022/0035074 A1
(43) Pub. Date: Feb. 3, 2022

(54) Method for Identifying Sunny and Rainy Moments by Utilizing Multiple Characteristic Quantities of High-frequency Satellite-ground Links

(71) Applicant: National University of Defense Technology, Changsha City (CN)

(72) Inventors: Xichuan Liu, Changsha City (CN); Minghao Xian, Changsha City (CN); Shuai Hu, Changsha City (CN); Taichang Gao, Changsha City (CN); Min Yin, Changsha City (CN)

(21) Appl. No.: 17/501,350

(22) Filed: Oct. 14, 2021

Related U.S. Application Data
(63) Continuation of application No. PCT/CN2021/081658, filed on Mar. 19, 2021.

(30) Foreign Application Priority Data
Mar. 30, 2020 (CN) 202010237859X

(51) Int. Cl. G01W 1/12

(52) U.S. Cl. CPC G01W 1/12

(57) ABSTRACT

A method for identifying sunny and rainy moments by utilizing multiple characteristic quantities of high-frequency satellite-ground links is provided. The method may include the following steps of: extracting multiple characteristic quantities including standard deviation, trend, maximum value, minimum value, average value, skewness, kurtosis and information entropy; selecting an optimal time window through adjustment; and finally realizing the identification of the sunny and rainy moments by utilizing a classification algorithm. According to the method for identifying the sunny and rainy moments, sunny and rainy periods can be accurately distinguished by utilizing the signals of the high-frequency satellite-ground links, and real-time monitoring of large-range sunny and rainy distribution conditions is achieved.

### TECHNICAL FIELD OF INVENTION

The invention relates to the field of meteorological detection, and in particular to a method for identifying sunny and rainy moments by utilizing multiple characteristic quantities of high-frequency satellite-ground links, and more specifically to a use of satellite-ground link signal changes to extract multiple characteristic quantities and a use of a classification algorithm to realize the identification of sunny and rainy moments.

### BACKGROUND OF INVENTION

Since the idea of measuring rainfall based on near-ground commercial microwave links was proposed in 1977, this new method of measuring rainfall using the near-ground microwave links has attracted wide attention from worldwide scholars and achieved rapid development due to its ease of operation, low cost, and high accuracy. At present, near-ground microwave links can not only realize the inversion of the average path rain intensity and path average raindrop spectrum, but also play an important role in radar calibration and regional precipitation monitoring, thereby becoming an auxiliary and supplement to traditional rainfall observation methods. However, there is still a big gap between the automation of rainfall measurement by microwave links and the use of services. An important factor restricting automatic rainfall detection is the identification of sunny and rainy moments, which directly affects the accuracy of rainfall detection results. At present, a large number of studies on how to use near-ground microwave links to distinguish sunny and rainy moments have been carried out, but the needs of practical applications still cannot be met.

The satellite-ground link is a special type of microwave links, and the method of using it to detect rainfall has become an emerging frontier issue. Generally speaking, the working frequency bands of the satellite-ground link are mostly concentrated in high-frequency bands such as L, C, Ku and Ka, and the signals of the satellite-ground link are susceptible to interference from external factors. At the same time, because the satellite-ground link passes through the entire layer of the atmosphere, the atmosphere is gas, cloud and fog. Signal changes may be more complicated than the near-ground microwave links due to various factors such as gas, cloud and fog, sand duct, scintillation, and rainfall. At present, the studies on the method of detecting rainfalls by the satellite-ground link have just started, and accurate identification of sunny and rainy moments is a necessary precondition for inverting the rainfall intensity. Therefore, realizing discrimination between sunny and rainy moments based on a satellite-ground link high-frequency signal can not only improve the accuracy of detecting the rainfalls by the satellite-ground link, but also is of great significance to promote widespread application of detecting rainfalls by the satellite-ground link.

### SUMMARY OF INVENTION

To overcome the defects in the prior art, the invention provides a method for identifying sunny and rainy moments by utilizing multiple characteristic quantities of high-frequency satellite-ground links, which extracts characteristic quantities with obvious difference by analyzing the change rule of a high-frequency signal, and uses a classification algorithm to realize identification of sunny and rainy moments.

To achieve the objective, the invention adopts technical solution as follows.

Specifically, a method for identifying sunny and rainy moments by utilizing multiple characteristic quantities of high-frequency satellite-ground links includes the following steps:

step 1: establishing high-frequency satellite-ground links;

step 2: carrying out time domain sampling on the high-frequency satellite-ground links at intervals of ΔT to obtain an original received signal SN;

step 3: filtering the original received signal SN with a wavelet analysis method and eliminating rapid changes caused by tropospheric scintillation to obtain a signal S(n);

step 4: extracting characteristic quantities of the signal S(n) for the signal S(n) at each moment;

step 5: adjusting a calculation window area Wᵢ of each characteristic quantity, and selecting an optimal time window W;

step 6: representing eigenvectors composed of the characteristic quantities obtained by the step 4 of the two signals at different moments with x₁ and x₂, selecting a Gaussian kernel function K(x₁, x₂) and a penalty factor C:

$$K ( {x}_{1} , {x}_{2} ) = exp ( - \frac{‖ {x}_{1} - {x}_{2} ‖}{2 {σ}^{2}} )$$

where σ represents a bandwidth and is used for controlling an action range of the Gaussian kernel function;

and constructing an optimization problem is constructed:

$${min}_{α} \frac{1}{2} {\sum }_{i = 1}^{n} {\sum }_{j = 1}^{n} {α}_{i} {α}_{j} {y}_{i} {y}_{j} K ( {x}_{i} , {x}_{j} ) - {\sum }_{i = 1}^{n} {α}_{i}$$

$$s . t . {\sum }_{i = 1}^{n} {α}_{i} {y}_{i} = 0$$

$$0 \leq {α}_{i} \leq C$$

where y represents classification results, and a represents a Lagrange multiplier;

step 7: solving an optimal α based on a quadratic programming problem, and constructing a decision function G(x) to distinguish between sunny and rainy moments:

$$G ( {x}_{i} ) = sign ( {\sum }_{i} {α}_{i} {y}_{i} K ( {x}_{i} , {x}_{j} ) + b )$$

$$b = {y}_{j} - {\sum }_{{i}^{″} ∈ SV} {α}_{{i}^{″}} {y}_{{i}^{″}} K ( {x}_{j} , {x}_{{i}^{″}} )$$

where SV represents a support vector.

In an embodiment of the invention, the method of filtering the original received signal SN with a wavelet analysis method in the step 3 includes: determining a wavelet decomposition level to be 3 firstly, then starting wavelet decomposition calculation, quantifying a threshold of high frequency coefficients of wavelet decomposition, and finally performing one-dimensional wavelet reconstruction according to low-frequency coefficients of a bottommost layer and high-frequency coefficients of each layer to obtain the signal S(n).

In an embodiment of the invention, the method of extracting characteristic quantities of the signal S(n) in the step 4 includes: selecting a given ideal time window W, and extracting the following characteristic quantities of the signal S(n) at a n-th moment, the characteristic quantities including:

(1) standard deviation (Std)

$$Std ( S ( n ) ) = [ \frac{1}{N + 1} {\sum }_{i = 1}^{N} {( S ( n - N + i ) - \overline{S} )}^{2} ] , N = W \text{/} Δ t$$

(2) trend (Trd)

$$Trd ( S ( n ) ) = \frac{1}{N} {\sum }_{i = - N \text{/} 2}^{N \text{/} 2} {α}_{i} S ( n + i ) , {α}_{i} = ( - 1 , - 1 , … - 1 , 0 , 1 … 1 )$$

(3) Maximum value (Max)

Max(S(n))=max(S(n−N+i)),i=1,2, . . . ,N

(4) Minimum value (Min)

Min(S(n))=min(S(n−N+i)),i=1,2, . . . ,N

(5) Average value (Ave)

$$Ave ( S ( n ) ) = \frac{1}{N} {\sum }_{i = 1}^{N} S ( n + i - N ) , i = 1 , 2 , 3 , … , N$$

(6) Kurtosis (Kur)

$$Kur ( S ( n ) ) = \frac{N ( N + 1 )}{( N - 1 ) ( N - 2 ) ( N - 3 )} {\sum }_{i = 1}^{N} {( \frac{S ( n - N + i ) - \overline{S}}{Std ( S ( n ) )} )}^{4} - \frac{3 {( N - 1 )}^{2}}{( N - 2 ) ( N - 3 )} , i = 1 , 2 , 3 , … , N$$

(7) Skewness (Ske)

$$Ske ( S ( n ) ) = ( \frac{1}{N} {\sum }_{i = 1}^{N} {( S ( n - N + i ) - \overline{S} )}^{3} ) \text{/} {( \frac{1}{N} {\sum }_{i = 1}^{N} {( S ( n - N + i ) - \overline{S} )}^{2} )}^{\frac{3}{2}} , i = 1 , 2 , 3 , … , N$$

(8) Information entropy (En)

$$En ( S ( n ) ) = {\sum }_{i = 1}^{N} - {p}_{i} log ( {p}_{i} ) , i = 1 , 2 , 3 , … , N$$

where Δt represents signal sampling time interval, S̅ represents an average value of signal intensity within a given time window, and pᵢ represents probability that a signal electric level value is S(n−N+i) at a (n−N+i)-th moment.

In an embodiment of the invention, the method of selecting an optimal time window W in the step 5 includes: maximizing an average Euclidean distance between the characteristic quantities at sunny and rainy moments:

$$max \frac{1}{{N}^{′} {M}^{′}} {\sum }_{{i}^{′} = 1}^{{N}^{′}} {\sum }_{{j}^{′} = 1}^{{M}^{′}} \sqrt{{\sum }_{k = 1}^{8} {( {R}_{{i}^{′} k} - {S}_{{j}^{′} k} )}^{2}}$$

where N′ is a number of rainy moments, M′ is a number of rainless moments, R_{i′k} is a k-th characteristic quantity at a i′-th rainy moment, and S_{j′k} is a k-th characteristic quantity at a j′-th rainless moment.

In an embodiment of the invention, a support vector machine SVM method is used to determine a sunny or rainy state at each moment in the step 7.

Compared with the prior art, the invention has the following beneficial effects:

For detecting rainfall by a satellite-ground link, the invention discloses a method for identifying sunny and rainy moments by utilizing characteristic quantities of the high-frequency satellite-ground links, which fully excavates the trend, kurtosis, and skewness contained in the signal, and takes the support vector machine (SVM) classification algorithm as an example to complete the identification of sunny and rainy moments. The invention plays a vital role in further study and improvement of a new method for detecting rainfalls by a satellite-ground link and promotion of its automatic detection.

### BRIEF DESCRIPTION OF DRAWINGS

FIG. 1 is an implementation flow chart of utilizing multiple characteristic quantities of high-frequency satellite-ground links; and

FIGS. 2A-2B are diagrams showing the effect of utilizing multiple characteristic quantities of high-frequency satellite-ground links to judge sunny and rainy moments.

### DETAILED DESCRIPTION OF EMBODIMENTS

The invention will be further illustrated with reference to the accompanying drawings and specific embodiments hereinafter. It should be understood that these embodiments are only used to illustrate the invention, and not to limit the scope of the invention. Various modifications of equivalents forms made by those skilled in the art shall fall within the scope of the invention as defined by the appended claims.

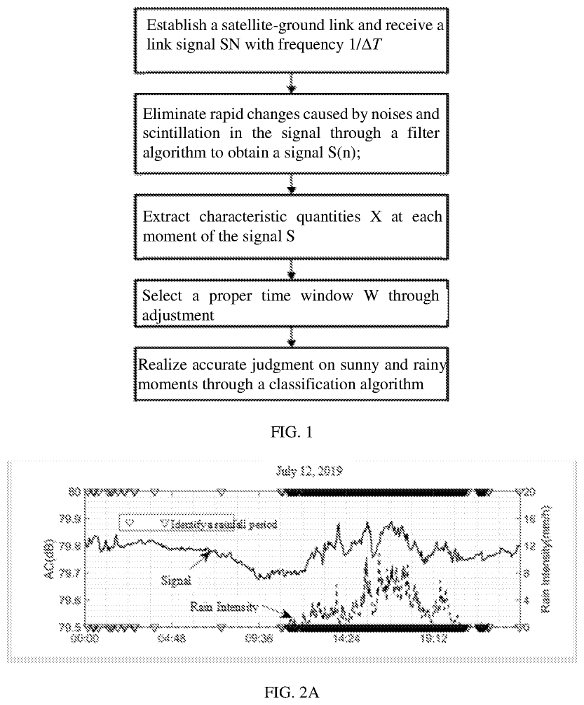

A method for identifying sunny and rainy moments by utilizing multiple characteristic quantities of high-frequency satellite-ground links is provided, which extracts signal characteristics at each moment by signals of the high-frequency satellite-ground links, and uses a classification algorithm to realize the identification of sunny and rainy moments. Taking wavelet analysis for filtering and a support vector machine for classification as an example, as shown in FIG. 1, the method includes the following steps:

step 1: establishing high-frequency satellite-ground links;

step 2: carrying out time domain sampling on the high-frequency satellite-ground links at intervals of ΔT to obtain an original received signal SN;

step 3: filtering the original received signal SN with a wavelet analysis method, and eliminating rapid changes caused by tropospheric scintillation to obtain a signal S(n);

specifically, in the step 3, a wavelet decomposition level is determined to be 3 by selecting Gaus wavelets firstly, then wavelet decomposition calculation is started, and a threshold of high frequency coefficients of wavelet decomposition is quantified, and finally one-dimensional wavelet reconstruction is performed according to according to low-frequency coefficients of a bottommost layer and high-frequency coefficients of each layer for filtering SN to obtain the signal S(n).

step 4: extracting eight characteristic quantities of the signal S(n) for the signal S(n) at each moment;

specifically, in the step 4, a given ideal time window W is selected and the following characteristic quantities of the signal S(n) at the n-th moment are extracted, the characteristic quantities including:

(1) Standard deviation (Std)

$$Std ( S ( n ) ) = [ \frac{1}{N + 1} {\sum }_{i = 1}^{N} {( S ( n - N + i ) - \overline{S} )}^{2} ] , N = W \text{/} Δ t$$

(2) Trend (Trd)

$$Trd ( S ( n ) ) = \frac{1}{N} {\sum }_{i = - N \text{/} 2}^{N \text{/} 2} {α}_{i} S ( n + i ) , {α}_{i} = ( - 1 , - 1 , … - 1 , 0 , 1 … 1 )$$

(3) Maximum value (Max)

Max(S(n))=max(S(n−N+i)),i=1,2, . . . ,N

(4) Minimum value (Min)

Min(S(n))=min(S(n−N+i)),i=1,2, . . . ,N

(5) Average value (Ave)

$$Ave ( S ( n ) ) = \frac{1}{N} {\sum }_{i = 1}^{N} S ( n + i - N ) , i = 1 , 2 , 3 , … , N$$

(6) Kurtosis (Kur)

$$Kur ( S ( n ) ) = \frac{N ( N + 1 )}{( N - 1 ) ( N - 2 ) ( N - 3 )} {\sum }_{i = 1}^{N} {( \frac{S ( n - N + i ) - \overline{S}}{Std ( S ( n ) )} )}^{4} - \frac{3 {( N - 1 )}^{2}}{( N - 2 ) ( N - 3 )} , i = 1 , 2 , 3 , … , N$$

(7) Skewness (Ske)

$$Ske ( S ( n ) ) = ( \frac{1}{N} {\sum }_{i = 1}^{N} {( S ( n - N + i ) - \overline{S} )}^{3} ) \text{/} {( \frac{1}{N} {\sum }_{i = 1}^{N} {( S ( n - N + i ) - \overline{S} )}^{2} )}^{\frac{3}{2}} , i = 1 , 2 , 3 , … , N$$

(8) Information entropy (En)

$$En ( S ( n ) ) = {\sum }_{i = 1}^{N} - {p}_{i} log ( {p}_{i} ) , i = 1 , 2 , 3 , … , N$$

where Δt represents a signal sampling time interval, S̅ represents an average value of signal intensity within a given time window, and pᵢ represents probability that a signal electric level value is S(n−N+i) at a (n−N+i)-th moment.

step 5: adjusting a calculation window area Wᵢ of each characteristic quantity, and selecting an optimal time window W to maximize an average Euclidean distance between the characteristic quantities at sunny and rainy moments;

$$max \frac{1}{{N}^{′} {M}^{′}} {\sum }_{{i}^{′} = 1}^{{N}^{′}} {\sum }_{{j}^{′} = 1}^{{M}^{′}} \sqrt{{\sum }_{k = 1}^{8} {( {R}_{{i}^{′} k} - {S}_{{j}^{′} k} )}^{2}}$$

where N′ is a number of rainy moments, M′ is a number of rainless moments, R_{i′k} is a k-th characteristic quantity at a i′-th rainy moment, and S_{j′k} is a k-th characteristic quantity at a j′-th rainless moment.

step 6: representing eigenvectors composed of the eight characteristic quantities obtained by the step 4 of two signals at different moments with x₁ and x₂, selecting a Gaussian kernel function K(x₁, x₂) and a penalty factor C:

$$K ( {x}_{1} , {x}_{2} ) = exp ( - \frac{‖ {x}_{1} - {x}_{2} ‖}{2 {σ}^{2}} )$$

where σ represents a bandwidth and is used for controlling an action range of the Gaussian kernel function;

and constructing an optimization problem:

$${min}_{α} \frac{1}{2} {\sum }_{i = 1}^{n} {\sum }_{j = 1}^{n} {α}_{i} {α}_{j} {y}_{i} {y}_{j} K ( {x}_{i} , {x}_{j} ) - {\sum }_{i = 1}^{n} {α}_{i}$$

$$s . t . {\sum }_{i = 1}^{n} {α}_{i} {y}_{i} = 0$$

$$0 \leq {α}_{i} \leq C$$

where y represents classification results, and a represents a Lagrange multiplier;

step 7: solving an optimal α based on a quadratic programming problem, and constructing a decision function G(x) to distinguish between sunny and rainy moments:

$$G ( {x}_{i} ) = sign ( {\sum }_{i} {α}_{i} {y}_{i} K ( {x}_{i} , {x}_{j} ) + b )$$

$$b = {y}_{j} - {\sum }_{{i}^{″} ∈ SV} {α}_{{i}^{″}} {y}_{{i}^{″}} K ( {x}_{j} , {x}_{{i}^{″}} )$$

where SV represents a support vector.

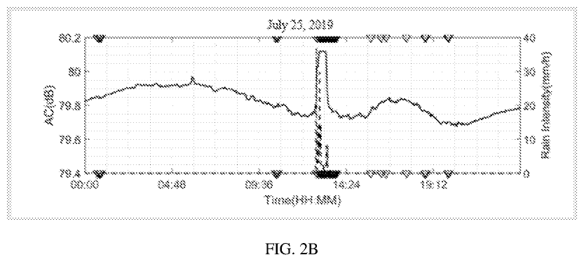

A support vector machine SVM method is utilized to judge the state of sunny and rainy moments. The timing results of the identification of the sunny and rainy moments are shown in FIG. 2A-2B. The method for identifying sunny and rainy moments of the invention can accurately distinguish the sunny and rainy periods by utilizing the signals of the high-frequency satellite-ground links. Real-time monitoring of a large-range sunny and rainy distribution condition is of great significance for further improving the accuracy of detecting rainfalls by the satellite-ground links, and prompt the urban water logging monitoring and flood early warning.

Although the above embodiments are based on wavelet filtering and support vector machines as examples, where it involves identifying sunny and rainy moments based on multiple characteristic quantities of high-frequency satellite-ground links, it should be pointed out that for those skilled in the art, several changes and modifications can be made without departing from the principle of the invention, and these changes and modifications should also be regarded as the protection scope of the invention.

What is claimed is:

1. A method for identifying sunny and rainy moments by utilizing multiple characteristic quantities of high-frequency satellite-ground links, comprising the following steps:
step 1: establishing high-frequency satellite-ground links;
step 2: carrying out time domain sampling on the high-frequency satellite-ground links at intervals of ΔT to obtain an original received signal SN;
step 3: filtering the original received signal SN with a wavelet analysis method and eliminating changes caused by tropospheric scintillation to obtain a signal S(n);
step 4: extracting characteristic quantities of the signal S(n), for the signal S(n) at each moment;
step 5: adjusting a calculation window area Wᵢ of each of the characteristic quantities, and selecting an optimal time window W;
step 6: representing eigenvectors composed of the characteristic quantities obtained by the step 4 of two signals at different moments with x₁ and x₂, selecting a Gaussian kernel function K(x₁, x₂) and a penalty factor C:
$$K ( {x}_{1} , {x}_{2} ) = exp ( - \frac{‖ {x}_{1} - {x}_{2} ‖}{2 {σ}^{2}} )$$
where σ represents a bandwidth and is used for controlling an action range of the Gaussian kernel function;
and constructing an optimization problem:
$${min}_{α} \frac{1}{2} {\sum }_{i = 1}^{n} {\sum }_{j = 1}^{n} {α}_{i} {α}_{j} {y}_{i} {y}_{j} K ( {x}_{i} , {x}_{j} ) - {\sum }_{i = 1}^{n} {α}_{i}$$
$$s . t . {\sum }_{i = 1}^{n} {α}_{i} {y}_{i} = 0$$
$$0 \leq {α}_{i} \leq C$$
where y represents classification results, and a represents a Lagrange multiplier;
step 7: solving an optimal α based on a quadratic programming problem, and constructing a decision function G(x) to distinguish between sunny and rainy moments:
$$G ( {x}_{i} ) = sign ( {\sum }_{i} {α}_{i} {y}_{i} K ( {x}_{i} , {x}_{j} ) + b )$$
$$b = {y}_{j} - {\sum }_{{i}^{″} ∈ SV} {α}_{{i}^{″}} {y}_{{i}^{″}} K ( {x}_{j} , {x}_{{i}^{″}} )$$
where SV represents a support vector.

2. The method for identifying sunny and rainy moments by utilizing multiple characteristic quantities of high-frequency satellite-ground links according to claim 1, wherein the method of filtering the original received signal SN with a wavelet analysis method in the step 3 comprises:
determining a wavelet decomposition level to be 3 firstly, then starting wavelet decomposition calculation, quantifying a threshold of high frequency coefficients of wavelet decomposition, and finally performing one-dimensional wavelet reconstruction according to low-frequency coefficients of a bottom-most layer and high-frequency coefficients of respective layers to obtain the signal S(n).

3. The method for identifying sunny and rainy moments by utilizing multiple characteristic quantities of high-frequency satellite-ground links according to claim 1, wherein the method of extracting characteristic quantities of the signal S(n) in the step 4 comprises:
selecting a given ideal time window W, and extracting the following characteristic quantities of the signal S(n) at a n-th moment, the characteristic quantities comprising:
(1) standard deviation (Std)
$$Std ( S ( n ) ) = [ \frac{1}{N + 1} {\sum }_{i = 1}^{N} {( S ( n - N + i ) - \overline{S} )}^{2} ] , N = W \text{/} Δ t$$
(2) trend (Trd)
$$Trd ( S ( n ) ) = \frac{1}{N} {\sum }_{i = - N \text{/} 2}^{N \text{/} 2} {α}_{i} S ( n + i ) , {α}_{i} = ( - 1 , - 1 , … - 1 , 0 , 1 … 1 )$$
(3) maximum value (Max)
Max(S(n))=max(S(n−N+i)),i=1,2, . . . ,N
(4) minimum value (Min)
Min(S(n))=min(S(n−N+i)),i=1,2, . . . ,N
(5) average value (Ave)
$$Ave ( S ( n ) ) = \frac{1}{N} {\sum }_{i = 1}^{N} S ( n + i - N ) , i = 1 , 2 , 3 , … , N$$
(6) kurtosis (Kur)
$$Kur ( S ( n ) ) = \frac{N ( N + 1 )}{( N - 1 ) ( N - 2 ) ( N - 3 )} {\sum }_{i = 1}^{N} {( \frac{S ( n - N + i ) - \overline{S}}{Std ( S ( n ) )} )}^{4} - \frac{3 {( N - 1 )}^{2}}{( N - 2 ) ( N - 3 )} , i = 1 , 2 , 3 , … , N$$
(7) skewness (Ske)
$$Ske ( S ( n ) ) = ( \frac{1}{N} {\sum }_{i = 1}^{N} {( S ( n - N + i ) - \overline{S} )}^{3} ) / {( \frac{1}{N} {\sum }_{i = 1}^{N} {( S ( n - N + i ) - \overline{S} )}^{2} )}^{\frac{3}{2}} , i = 1 , 2 , 3 , … , N$$
(8) information entropy (En)
$$En ( S ( n ) ) = {\sum }_{i = 1}^{N} - {p}_{i} log ( {p}_{i} ) , i = 1 , 2 , 3 , … , N$$
where Δt represents a signal sampling time interval, S̅ represents an average value of signal intensity within a given time window, and pᵢ represents probability that a signal electric level value is S(n−N+i) at a (n−N+i)-th moment.

4. The method for identifying sunny and rainy moments by utilizing multiple characteristic quantities of high-frequency satellite-ground links according to claim 1, wherein a method of selecting the optimal time window W in the step 5 comprises:
maximizing an average Euclidean distance between the characteristic quantities at sunny and rainy moments:
$$max \frac{1}{{N}^{′} {M}^{′}} {\sum }_{{i}^{′} = 1}^{{N}^{′}} {\sum }_{{j}^{′} = 1}^{{M}^{′}} \sqrt{{\sum }_{k = 1}^{8} {( {R}_{{i}^{′} k} - {S}_{{j}^{′} k} )}^{2}}$$
where N′ is a number of rainy moments, M′ is a number of rainless moments, R_{i′k} is a k-th characteristic quantity at a i′-th rainy moment, and S_{j′k} is a k-th characteristic quantity at a j′-th rainless moment.

5. The method for identifying sunny and rainy moments by utilizing multiple characteristic quantities of high-frequency satellite-ground links according to claim 1, wherein a support vector machine SVM method is used to determine a sunny or rainy state at each moment in the step 7.
